(19) United States
(12) Patent Application Publication
(10) Pub. No.: US 2016/0110346 A1
(43) Pub. Date: Apr. 21, 2016

(54) MULTILINGUAL CONTENT PRODUCTION

(71) Applicants: Christian Lieske, Malsch (DE); Jochen Geib, Speyer (DE); Krasimir Semerdzhiev, Schwetzingen (DE); Guenther Fischer, Nussloch (DE); Thomas Jargstorff, Heilbronn (DE); Matthias Becker, Weisenheim/Sand (DE); Sven Leukert, Walldorf (DE); Peter Muessig, Untereisesheim (DE); Stefan Beck, Hirschberg (DE)

(72) Inventors: Christian Lieske, Malsch (DE); Jochen Geib, Speyer (DE); Krasimir Semerdzhiev, Schwetzingen (DE); Guenther Fischer, Nussloch (DE); Thomas Jargstorff, Heilbronn (DE); Matthias Becker, Weisenheim/Sand (DE); Sven Leukert, Walldorf (DE); Peter Muessig, Untereisesheim (DE); Stefan Beck, Hirschberg (DE)

(21) Appl. No.: 14/517,714

(22) Filed: Oct. 17, 2014

(51) Int. Cl. G06F 17/28

(52) U.S. Cl. CPC G06F 17/28

(57) ABSTRACT

A method, implemented at least in part by a computing device, for provisioning multilingual content, may include receiving by the computing device, a selection of a language-agnostic artefact, the language-agnostic artefact including programming code for displaying a user interface with a text field. An input string designating at least a portion of a text label associated with the text field may be received. A multilingual artefact may be retrieved based on the received input string, from a plurality of available multilingual artefacts. The retrieved multilingual artefact may include a plurality of translations of the input string into a plurality of human languages. An association record identifying an association between the language-agnostic artefact and the multilingual artefact may be created.

### BACKGROUND

As enterprises accumulate ever-greater amounts of data on their transactions, processes, products, and operations, online analytical processing has become an important part of doing business. The number of tools and techniques addressing analytical processing has grown, enabling data analysts to quickly analyze and navigate through vast and complex collections of data using processing software and platforms. In a computing environment with many computing devices, such as a network environment (e.g., a cloud computing environment or other network environments) with many server computers, the use of computing resources can provide a number of advantages including cost advantages and/or the ability to adapt rapidly to changing computing resource needs.

With the increased use of computing resources, reliability and usability of software deployment in a multilingual environment is essential. For example, content or software that is created/authored in one human language (i.e., original language) for one locale (e.g. the French-speaking part of Canada) often needs to be made available in additional human languages or adapted with regard to other cultural aspects. However, multilingual content production faces various challenges in quality-cost-delivery (QCD) dimensions. Examples of such challenges include lack of quality of original language content, linguistic and consistency issues where quality dimensions include correctness related to spelling, terminology, grammar/syntax and style, efforts and delays related to review of original language content and translation(s), as well as late availability of translations which can have a negative impact on in-country testing opportunities, or early market entry.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

In an example aspect of the disclosure, a method, implemented at least in part by a computing device, for provisioning multilingual content, may include receiving by the computing device, a selection of a language-agnostic artefact, which may include programming code for displaying a user interface with a text field. An input string designating at least a portion of a text label associated with the text field may be received. A multilingual artefact may be retrieved based on the received input string, from a plurality of available multilingual artefacts. The retrieved multilingual artefact may include a plurality of translations of the input string into a plurality of human languages. An association record identifying an association between the language-agnostic artefact and the multilingual artefact may be created.

In another aspect of the disclosure, a computer-readable storage is disclosed and may include instructions for provisioning multilingual content. The method may include generating a language-agnostic artefact, which may include programming code for displaying a user interface with a text field. A query may be received. The query may include an input string for completing the text field, and metadata information designating a desired text type associated with the text field. A list of multilingual artefacts may be retrieved based on at least a portion of the received input string and the metadata information. Each multilingual artefact may include a plurality of translations of the at least a portion of the input string into a plurality of human languages. A selection of a multilingual artefact from the list of a plurality of multilingual artefacts may be received. An association record identifying an association between the language-agnostic artefact and the selected multilingual artefact may be created.

In yet another aspect of the disclosure, a computing device is disclosed which includes a processor and a memory. The computing device may be adapted to perform a method for provisioning multilingual content. The method may include receiving a selection of a language-agnostic artefact, which may include programming code for displaying a user interface (or another type of data structure) with a text field. An input designating at least a portion of a text label associated with the text field may be received. A plurality of suggested text labels for the text field may be retrieved. The retrieving may be based on the received input. Each suggested text label may include a main label for the text field, which label may be in a first human language, and at least one additional label representing a translation of the main label in at least a second human language. The suggested text label may also include (or be associated with) an identifier designating a label type for the main label. In response to receiving a selection of one of the plurality of suggested text labels, a multilingual artefact may be generated. The multilingual artefact includes a plurality of multilingual resource files identifying the main label and the at least one additional label. An association record identifying an association between the language-agnostic artefact and the multilingual artefact may be created. The association record may be stored in network storage. The stored association record may be accessed by at least one of: information identifying the language-agnostic artefact, information identifying the main label, or information identifying the at least one additional label within the multilingual artefact.

As described herein, a variety of other features and advantages can be incorporated into the technologies as desired.

### BRIEF DESCRIPTION OF THE DRAWINGS

FIG. 1 is a block diagram of an interaction between an application server and a multilingual content provisioning service (MCPS), in accordance with an example embodiment of the disclosure.

FIG. 2 illustrates examples of language-agnostic artefacts (LAA) and multilingual artefacts (MLA), in accordance with an example embodiment of the disclosure.

FIG. 3 illustrates example storage for multilingual artefacts and associations, in accordance with an example embodiment of the disclosure.

FIG. 4 illustrates an alternative implementation of multilingual artefacts, in accordance with an example embodiment of the disclosure.

FIG. 5 is an example flow diagram for generating multilingual artefacts and associations, in accordance with an example embodiment of the disclosure.

FIGS. 6-8 illustrate example views of a user interface, which can be used for selecting a multilingual artefact, in accordance with an example embodiment of the disclosure.

FIGS. 9-10 illustrate automatic externalization and creation of language-specific resources in connection with selecting a multilingual artefact, in accordance with an example embodiment of the disclosure.

FIGS. 11-13 are flowcharts of example methods for provisioning multilingual content, in accordance with an example embodiment of the disclosure.

FIG. 14 is a diagram of an example computing system, in which described embodiments can be implemented.

FIG. 15 is an example cloud computing environment that can be used in conjunction with the technologies described herein.

### DETAILED DESCRIPTION

The technologies described herein can be used in an application code development and testing environment as well as in multilingual content production environment where content or software is authored in one (human) language but needs to be adapted in one or more additional (human) languages. In some instances, multilingual content production can be based on one or more “core” activities, such as: a separation between language-agnostic artefacts (e.g., a user interface control such as a software button), and language-/locale-sensitive artefacts or multilingual artefacts (e.g., a text label in French attached to a software button); unassisted, original content creation (e.g., allowing software developers to create arbitrary strings/texts as labels for user interface controls such as software buttons); a dedicated phase (which may include human language translation) to create multilingual artefacts; language-related reviews (e.g., performed in-country by subject-matter experts); and correction cycles (to implement observations from the language-related reviews). In addition to these “core” activities, “context” activities such as recruiting translators, setting up translation workflows, organizing billing and the like may be needed. As used herein, the term “multilingual artefact” includes language-sensitive and locale-sensitive artefacts.

In other instances, a “straight-through” delivery and deployment of multilingual artefacts may be used to perform multilingual content production (or provisioning), without the need for reviews or any correction cycles. More specifically, after a language-agnostic artefact is created (or selected), a multilingual artefact may be created (e.g., by merging frequently-used terms in one or more human languages, or selected from a plurality of existing multilingual artefacts), the multilingual artefact can be automatically externalized (e.g., by generating a unique resource identifier and inserting it in the code for the language-agnostic artefact), and can also provide language-specific resources (e.g., translation of a text label used in the language-agnostic artefact).

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

As used herein, the term “application program” (sometimes shortened to application) can refer to any program designed to perform a specific function directly for the user or, in some cases, for another application program. Examples of application programs include word processors; database programs; Web browsers; network administration tools; development tools; drawing, paint, and image editing programs; and communication programs. Application programs use the services of the computer's operating system and other supporting programs.

As used herein, the term “artefact” can include a data structure or other types of data, and can be classified as, for example, a language-agnostic artefact (LAA) and a language-/locale-sensitive artefact (also referred to as a “polyglot” artefact or a multilingual artefact (MLA)). The LAA may include one or more coded assets, such as programming code for a user interface, e.g. a software button, or another type of coded asset. The LAA may also include code for displaying a text input box (field). The MLA may include a data capsule (or structure) for equivalent strings/translations in multiple human languages. The MLA may include a resource identifier, which may be used to link to (or otherwise identify) one or more files (or other resources) that include the multilingual translations of a text string. In some instances the MLA may link back to the LAA, for which it has been created. One or more of the figures may use the terms language-/locale-sensitive artefacts (LSAs) (or polyglot artefacts), which terms are equivalent to multilingual artefacts (or MLAs).

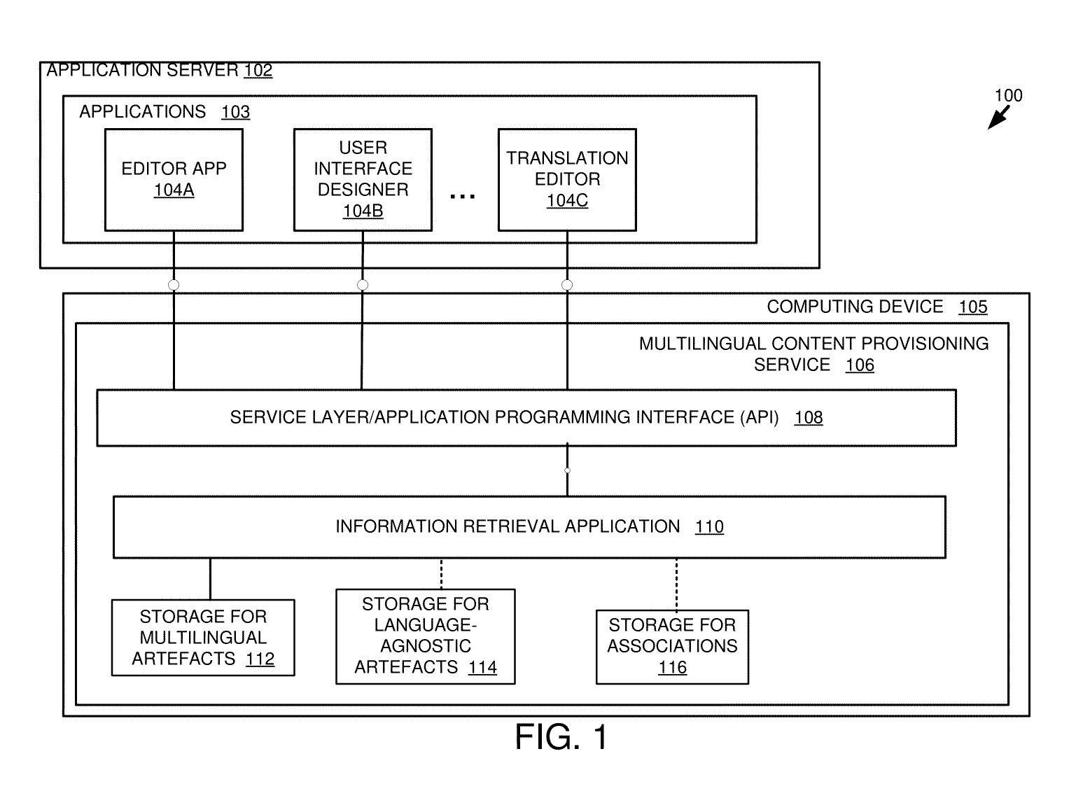

FIG. 1 is a block diagram of an interaction between an application server and a multilingual content provisioning service (MCPS), in accordance with an example embodiment of the disclosure. Referring to FIG. 1, the computing system 100 may include an application server 102 communicatively coupled with a computing device 105 running a multilingual content provisioning service (MCPS) 106. The application server 102 may comprise suitable logic, circuitry, interfaces, and/or code and may be operable to provide access (e.g., for downloading) to one or more applications, such as application 103. The applications 103 may include, for example, an editor application 104a, a code designer application (e.g., a user interface designer) 104b, and a translation editor application 104c. Other types of applications may also be provided by the application server 102. In some instances, the applications 103 may be loaded to (and run from) a browser, and the browser may be communicatively coupled to the application server 102 for exchange of any data used by the applications 103.

The MCPS 106 may comprise suitable logic, circuitry, interfaces, and/or code and may be operable to provide services associated with generating (or retrieving) multilingual artefacts and other multilingual artefacts-related services. The MCPS 106 may include an information retrieval application 110, which may be used to retrieve various types of artefacts as well as to generate and store associations between LAAs and MLAs. The information retrieval application 110 may be coupled with storage 112 for multilingual artefacts (MLA), storage 114 for language-agnostic artefacts (LAA), and storage 116 for associations. The information retrieval application 110 may be used to perform the core functionalities of the multilingual content provisioning service 106, which may be exposed (e.g., to applications 103) via the API 108. Additionally, in some instances, the application 110 may have direct access to the storage 112, and indirect access to storages 114 and 116 (e.g., application 110 may access storages 114, 116 via one or more of the applications 103).

The computing device 105 can be a smart phone or other wireless phone, a laptop or netbook computer, a tablet or notepad computer, a wearable computer, a mobile station, an entertainment appliance, an audio and/or video playback device, a game console, an automotive computer, and so forth. The computing device 105 can also be referred to as being a mobile device because the device 105 may be designed or intended to be moved to multiple different locations (e.g., taken by a user with him or her as the user goes to different locations).

The computing device 104 may comprise suitable logic, circuitry, interfaces, and/or code and may be operable to implement the MCPS 106 penning the functionalities described herein. The MCPS 106 may be implemented as a separate application or as part of an operating system for the device 105. Additionally, even though the MCPS 106 is illustrated separately from the applications 103, in some instances MCPS 106 may be part of the applications 103 within the server 102. Alternatively, one or more of the applications 103 as well as the MCPS 106 may be implemented as part of (or running on) the computing device 105.

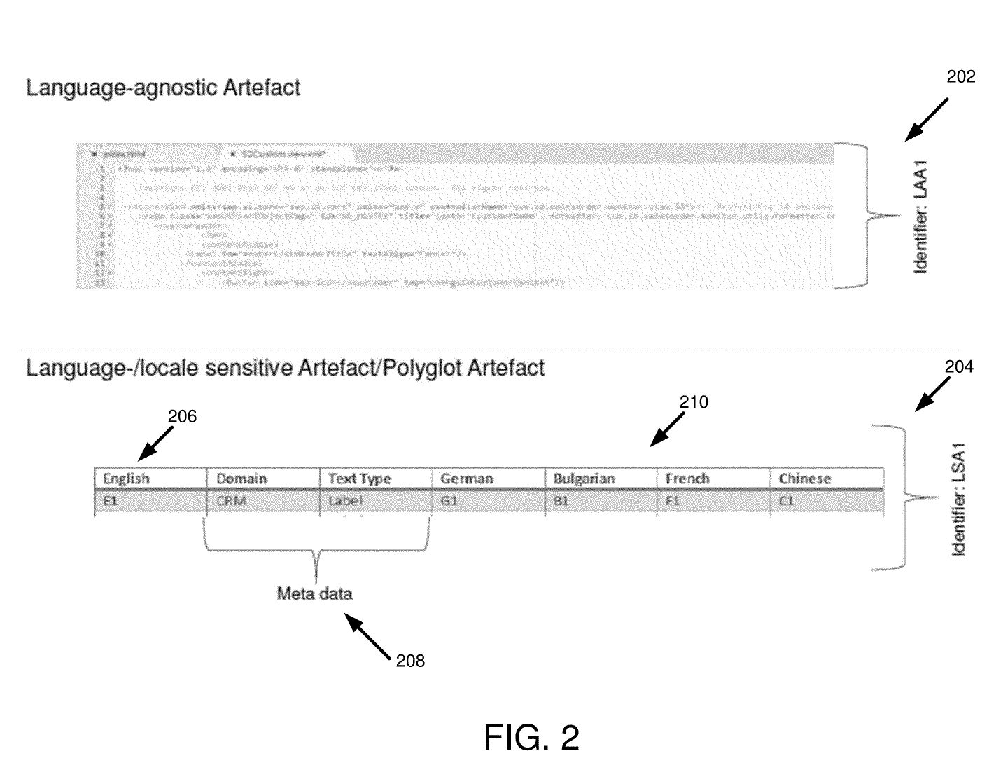

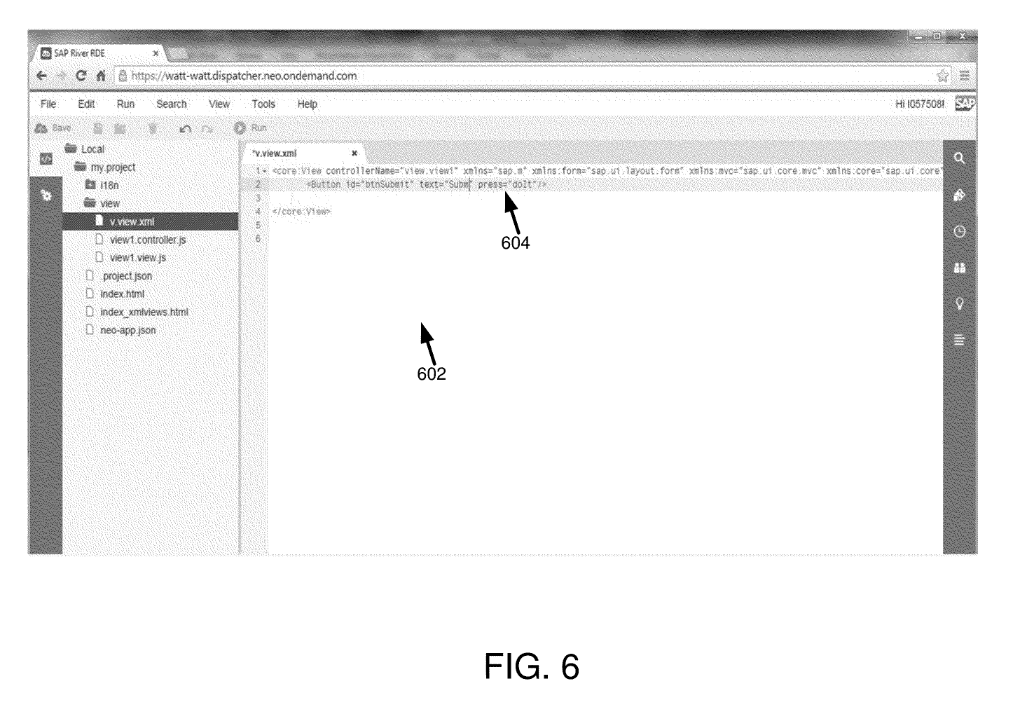

FIG. 2 illustrates examples of language-agnostic artefacts (LAA) and multilingual artefacts (MLA), in accordance with an example embodiment of the disclosure. Referring to FIG. 2, the LAA 202 may include one or more coded assets, such as programming code (or code snippets) for a user interface, e.g. a software button, or another type of coded asset. The LAA may also include code for displaying a text input box (field), as seen for example in FIG. 6.

One or more of the figures may use the terms language-/locale-sensitive artefacts (LSAs) (or polyglot artefacts), which terms are equivalent to multilingual artefacts (or MLAs). The MLA 204 may include a data capsule (or structure) for equivalent strings/translations in multiple human languages. For example, the MLA 204 may include a main text string 206 in English (e.g., indicated as E1), and corresponding translations 210 of the string E1 into one or more additional human languages (e.g., G1 in German, B1 in Bulgarian, F1 in French and C1 in Chinese). The MLA 204 may also include metadata information 208. The metadata 208 may include domain information indicating subject area of usage of the MLA, as well as a text type indicating the type of text for the string 206 (and 210) (in the example of FIG. 2, the text type is “label” indicating that the text string 206 is used as a text label on, e.g., a software button). Multiple domains may be stored in a single repository (e.g., repository for the metadata 208). Some example text type/string categories include:

XACT Accessibility

XALT Alternative text

XBCB Breadcrumb step

XBLI Bullet list item text

XBUT Button text

XCAP Caption

XCEL Cell

XCKL Checkbox

XCOL Column header

XCRD Tabstrip

XDAT Data navigation text

XFLD Label

XFRM Frame

XGLS Term

XGRP Group title

XHED Heading

XLGD Legend text

XLNK Hyperlink text

XLOG Log entry

XLST List box item

XMEN Menu header

XMIT Menu item

XMSG Message text

XRBL Radiobutton

XRMP Roadmap step

XROW Table Row Heading

XSEL Selection text

XTBS Tab strip text

XTIT Table Title

XTND Tree node text

XTOL Quick info text

XTXT General text

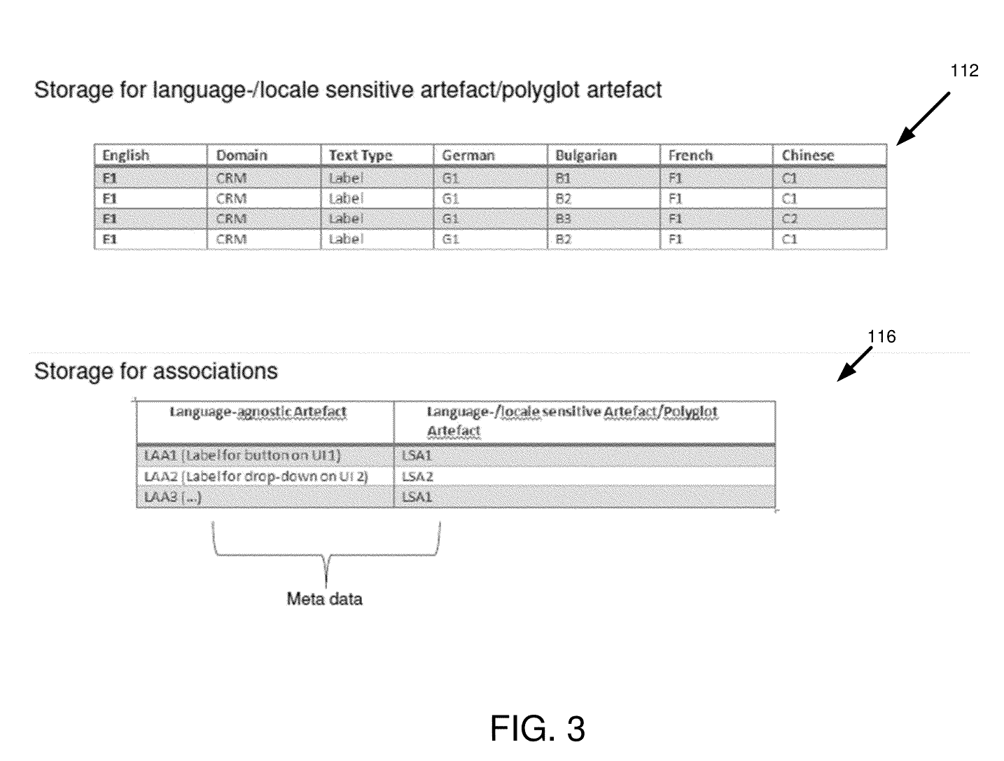

FIG. 3 illustrates example storage for multilingual artefacts and associations, in accordance with an example embodiment of the disclosure. Referring to FIG. 3, the storage 112 for MLAs may be used to store a plurality of MLAs in a table format, as seen in FIG. 3. Even though the MLAs in the example are stored with five human language translations per entry and two types of metadata (domain and text type), other human languages, metadata and/or other additional information may be used per MLA entry as well.

The storage for associations 116 may be used to store one or more associations between LAAs and MLAs. More specifically, each association may be stored as an LAA-MLA pair indicating that a specific MLA is associated with a LAA. The storage for associations 116 may be used in instances when, for example, the LAA is known (e.g., a design engineer or production process is using LAA1), then the storage 116 may indicate that previously LAA1 was associated with LSA1 (which is the same as MLA1), and multilingual content associated with MLA1 may be presented to the design engineer for consideration and used in production processes that relate to LAA1.

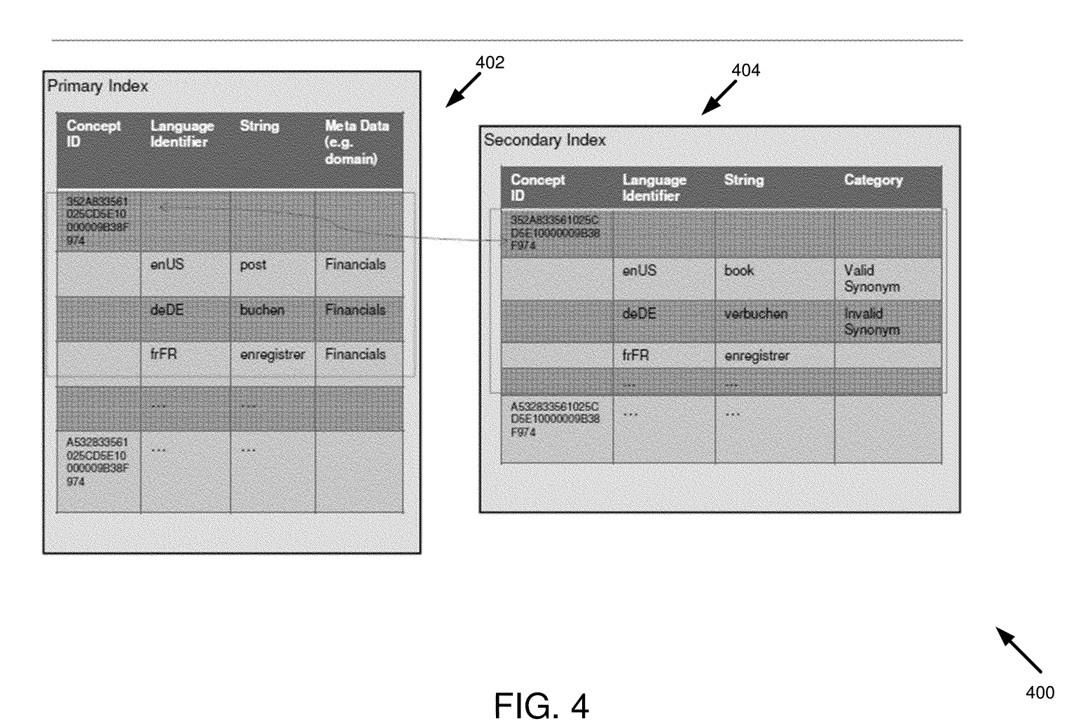

FIG. 4 illustrates an alternative implementation of multilingual artefacts, in accordance with an example embodiment of the disclosure. Referring to FIG. 4, there is illustrated an alternative implementation for a multilingual artefact 400. More specifically, the MLA 400 may include two tables, referred to as a primary index table 402 and a secondary index table 404. The primary index table 402 may include a concept identification (ID), a language identifier, the text string, and metadata (e.g., domain information). In the specific example in FIG. 4, the primary index table 402 includes the translation of the verb “post” in German and French.

The secondary index table 404 may include additional linguistic information associated with the string in the primary index table 402. For example, the secondary index table may be accessed based on the concept ID associated with the entry. The secondary index table 404 may also include one or more additional synonyms of the word associated with the main string (e.g., the English language translation). Additionally, the secondary index table may include a category metadata, which may indicate, for example, whether the string in the secondary index table is a valid (or invalid) synonym of the string in the primary index table 402 (e.g., the verb “book” is a valid synonym of “post”, but the German verb “verbuchen” is not).

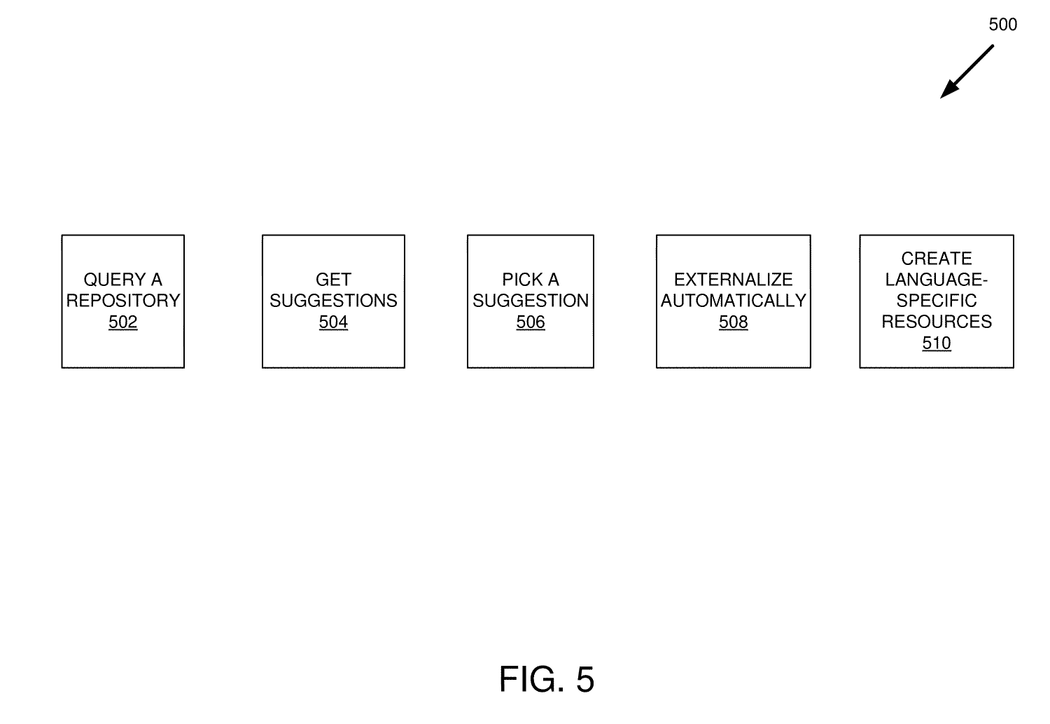

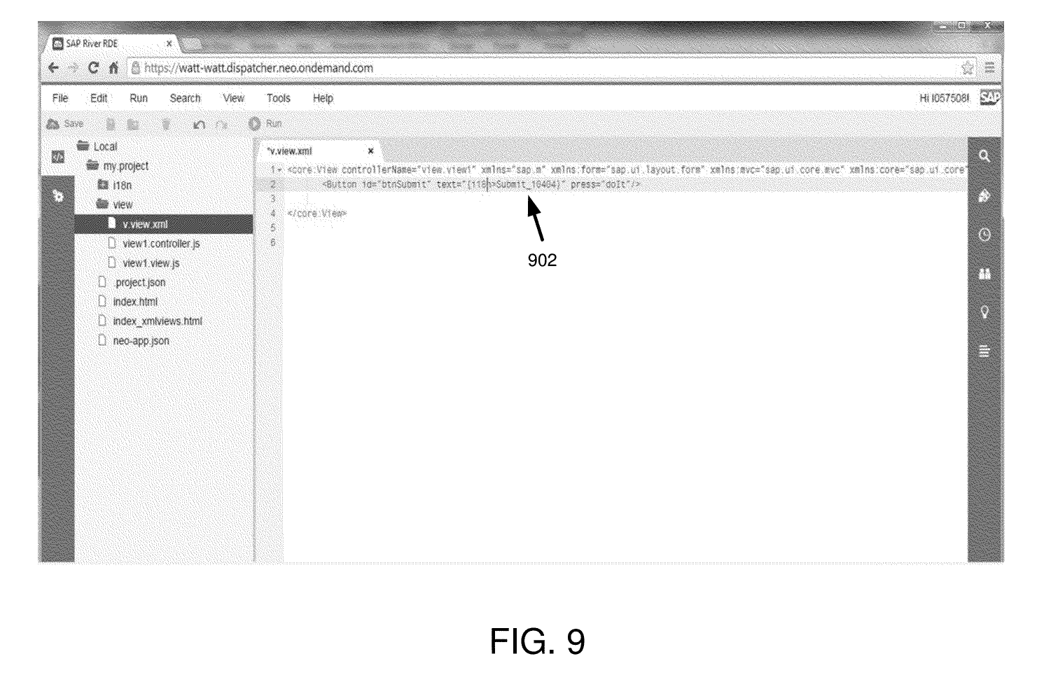

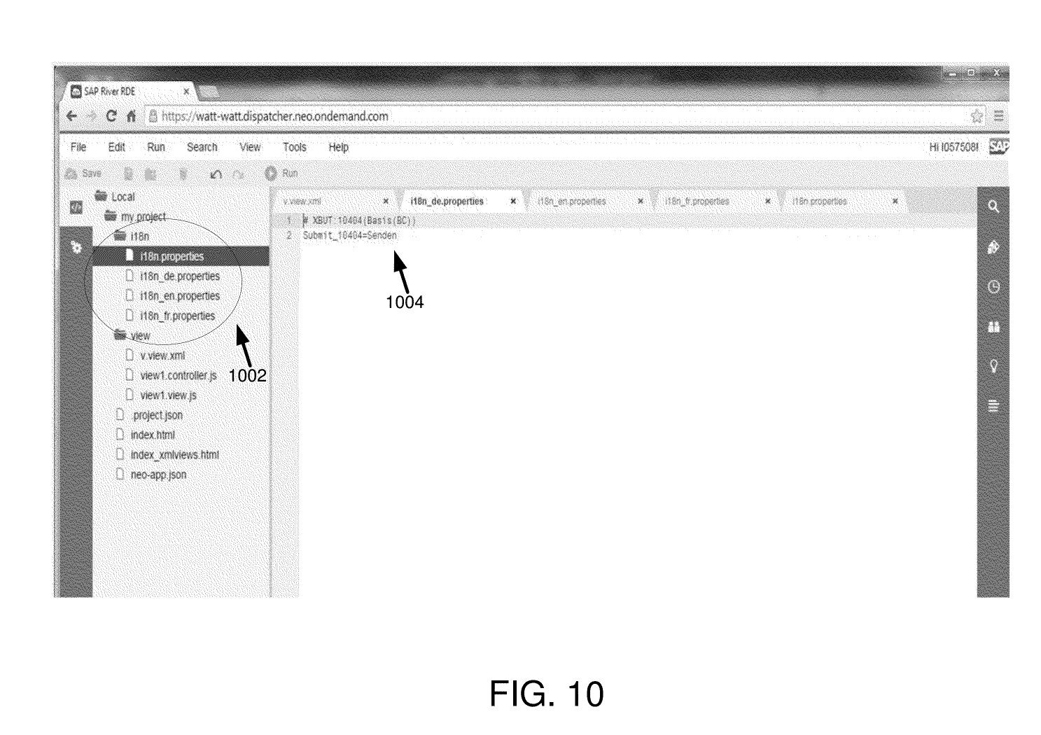

FIG. 5 is an example flow diagram for generating multilingual artefacts and associations, in accordance with an example embodiment of the disclosure. FIGS. 6-10 illustrate in greater detail flow diagram steps 502-510, respectively. More specifically, FIGS. 6-8 illustrate example views of a user interface, which can be used for selecting a multilingual artefact, in accordance with an example embodiment of the disclosure. FIGS. 9-10 illustrate automatic externalization and creation of language-specific resources in connection with selecting a multilingual artefact, in accordance with an example embodiment of the disclosure.

Referring to FIGS. 1 and 5-10, the example flow diagram 500 may start at 502, when a multilingual artefacts repository (e.g., 112) may be queried. For example, the one or more of the applications 103 (e.g., user interface designer application 104b) may use an API request 108 to access the information retrieval application 110. The user interface designer application 104b may be used to retrieve (or design) a LAA 602 (e.g., code for displaying a user interface). The LAA 602 may include code (e.g., line 2 in FIG. 6) for a software button with a text label (or field) 604. The MLA repository 112 may be queried by, for example, completing a partial or full text string (e.g., partial string “Subm”) in the text label/field 604.

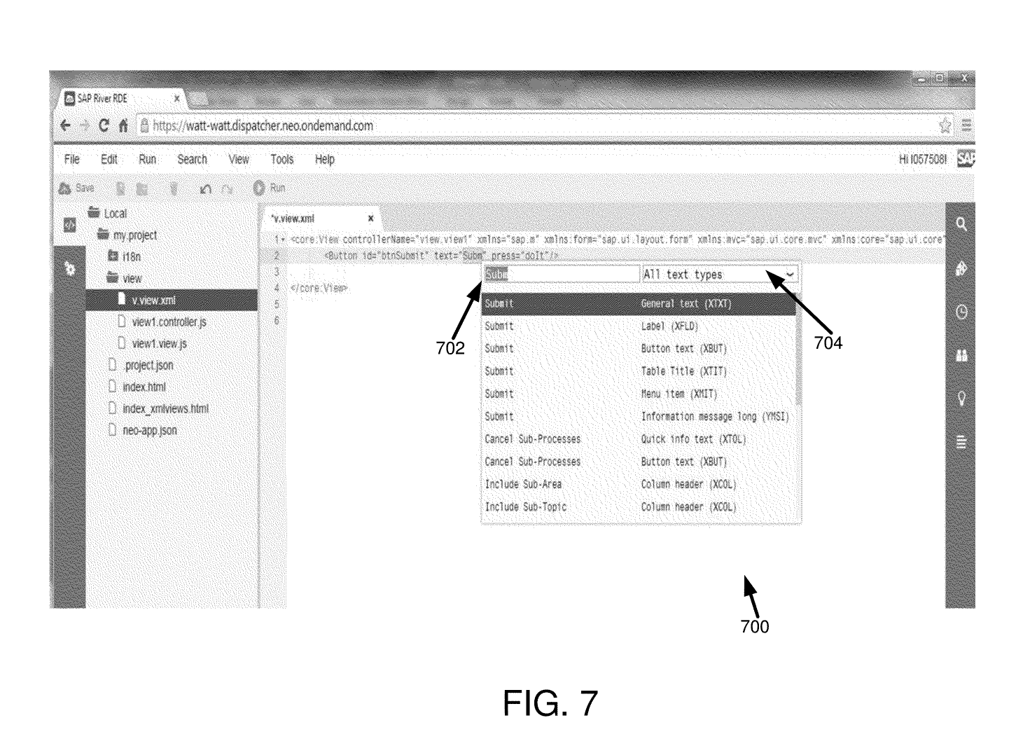

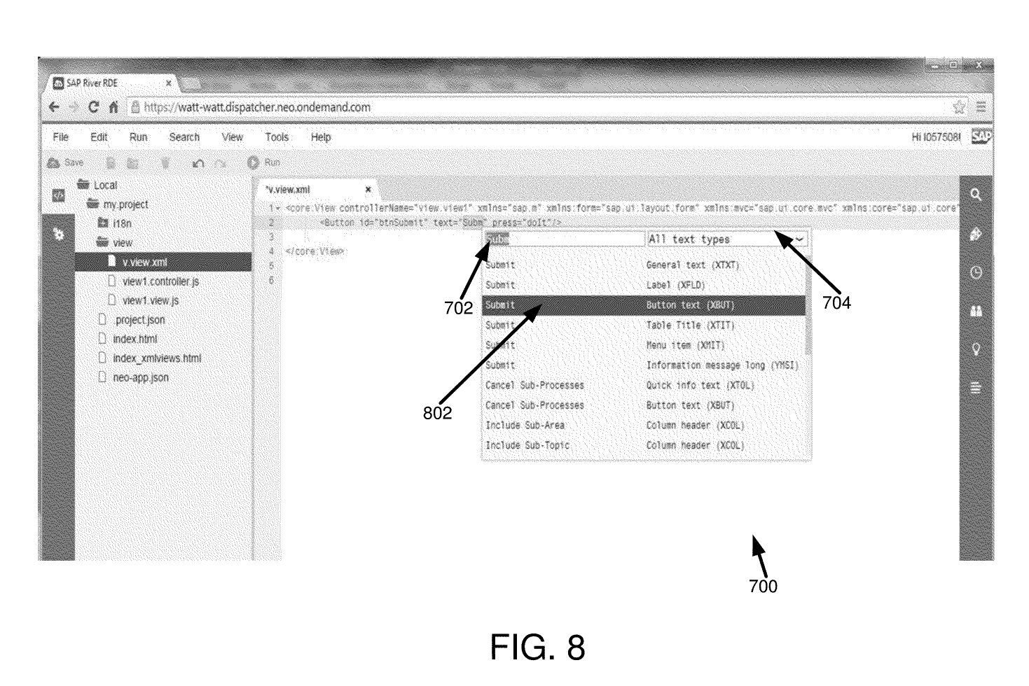

A user interface 700 may be displayed (FIG. 7), which may be used to provide one or more suggestions (step 504) based on the entered partial string 702 (“Subm”). The user interface 700 may be displayed automatically upon entering one or more characters of the partial string 702, or may be displayed based on activation (e.g., by pressing a software button and triggering an API request 108). The interface 700 may include a text box for entering the text string 702 as well as a separate text entry box to specify text type 704. Search of available MLAs may be performed using one or both of the entries 702 and 704. Additional user interface text entry boxes may be provided as additional search criteria (e.g., a domain entry box may be provided for specifying a domain or a database associated with the text string 702). MLA 802 may be selected from the displayed list of MLAs within the user interface 700 (step 506 and FIG. 8). In the example of FIG. 8, the MLA 802 for text string “Submit” with text type “Button text” is selected for use within the LAA 602.

After the MLA 802 is selected, an automatic resource externalization (e.g., 508) may be performed (e.g., by the information retrieval application 110 or another component of the MCPS 106). More specifically, upon selection of the MLA 802, a resource identifier 902 may be automatically generated and inserted in the text label/field 604 of the LAA 602. A language specific resource may then be created (or retrieved) at 510, which may be associated with the MLA 802. More specifically, the language-specific resources of MLA 802 may include a collection of multilingual resource files 1002 (e.g., “.properties” files) associated with the selected multilingual artefact 802. Each multilingual resource file from the files 1002 may include metadata information 1004. The metadata information 1004 may include a corresponding translation of an input string into at least one human language. In some instances, 1004 may include core content/payload data instead of metadata. Such core content may include source human language or additional translations. As seen in FIG. 10, the “ii8n_de.properties” tab is selected and the German translation of the input string “submit” is seen as “senden” in line 2 of the metadata 1004. This language-specific resource can be represented as a key-value pair. In FIG. 10, the key is “Submit_10404”, which is the resource identifier 902, and the value is the German translation “senden”. The metadata information 1004 may further include (e.g., in line 1) an identification of the text type 704 (e.g., XBUT) and domain (e.g., BC). After the resource identifier 902 is inserted in the LAA 602, the resource files 1002 are generated so that a subsequent selection of a language-specific resource (e.g., a specific human language translation) from the files 1002 may be performed.

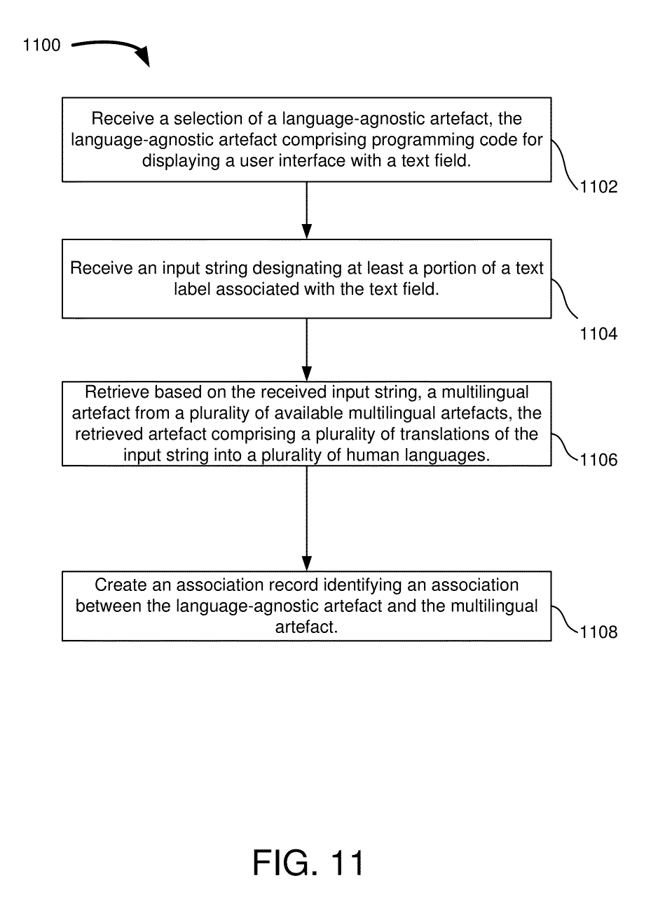

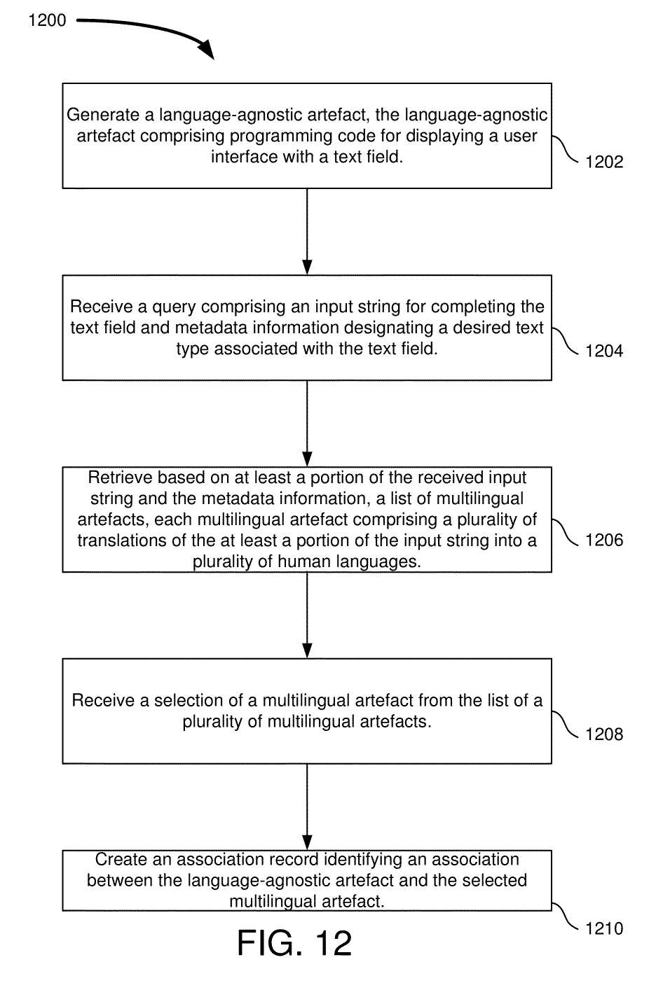

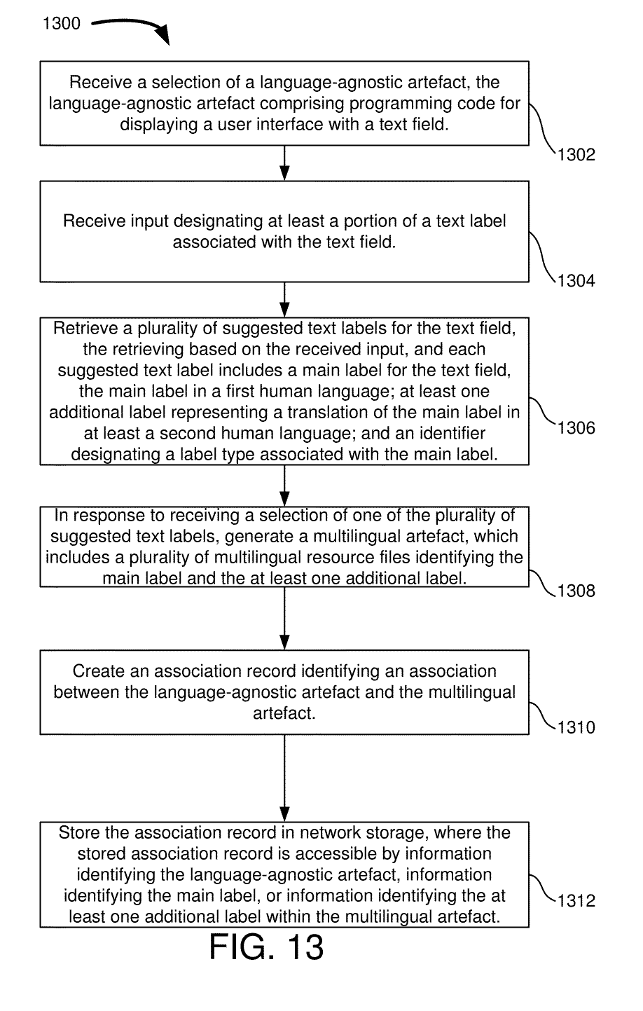

FIGS. 11-13 are flowcharts of example methods for provisioning multilingual content, in accordance with an example embodiment of the disclosure. Referring to FIGS. 1-11, the example method 1100 may start at 1102, when a selection of a language-agnostic artefact (e.g., LAA 602) may be received at the MCPS 106 running on device 105. The language-agnostic artefact (LAA 602) may include code for displaying a user interface with a text field (e.g., 604). At 1104, an input string may be received (e.g., 702) designating at least a portion of a label associated with the text field (604). At 1106, a multilingual artefact (e.g., 802) may be retrieving based on the received input string (702) from a plurality of available multilingual artefacts (e.g., the MLAs listed in the user interface 700). The retrieved multilingual artefact (802) may include a plurality of translations of the input string (e.g., “submit”) into a plurality of human languages (e.g., as designated by resource files 1002). At 1108, an association record identifying an association between the language-agnostic artefact (602) and the multilingual artefact (802) may be created (e.g., as stored in associations storage 116).

Referring to FIGS. 1-10 and 12, the example method 1200 may start at 1202, when a language-agnostic artefact (e.g., 602) may be generated or retrieved from storage (e.g., 114). The language-agnostic artefact (602) may include programming code for displaying a user interface with a text field (e.g., 604). At 1204, a query may be received at the MCPS 106 (e.g., via an API request 108). The query may include an input string (e.g., 702) for completing the text field, and metadata information designating a desired text type (e.g., 704) associated with the text field. At 1206, a list of multilingual artefacts (e.g., list of MLAs in user interface 700) may be retrieving based on at least a portion of the received input string (702) and/or the metadata information (704). Each multilingual artefact may include a plurality of translations (e.g., files 1002) of the at least a portion of the input string into a plurality of human languages. At 1208, a selection of a multilingual artefact (e.g., 802) may be received from the list of a plurality of multilingual artefacts. At 1210, an association record identifying an association between the language-agnostic artefact (602) and the selected multilingual artefact (802) may be created.

Referring to FIGS. 1-10 and 13, the example method 1300 may start at 1302, when a selection of a language-agnostic artefact (602) may be received. The language-agnostic artefact (602) may include programming code for displaying a user interface with a text field (604). At 1304, input (e.g., 702) designating at least a portion of a text label associated with the text field may be received. At 1306, a plurality of suggested text labels for the text field may be retrieved (e.g., the MLAs listed in user interface 700) based on the received input (702). Each suggested text label may include: a main label for the text field (e.g., the text strings in the left column inside user interface 700), the main label being in a first human language (e.g., in English); at least one additional label representing a translation of the main label in at least a second human language (e.g., the MLAs stored in 112 as illustrated in FIG. 3); and an identifier designating a label type associated with the main label (e.g., 704). At 1308, in response to receiving a selection of one of the plurality of suggested text labels, a multilingual artefact (e.g., 802) may be generated (or retrieved from storage 112). The multilingual artefact (802) may include (or otherwise be associated with) a plurality of multilingual resource files (e.g., 1002) identifying the main label (the English language translation) and the at least one additional label (e.g., at least one additional human language translation). At 1310, an association record (e.g., as stored in 116 in FIG. 3) identifying an association between the language-agnostic artefact (602) and the multilingual artefact (802) may be created. At 1312, the association record may be stored in network storage (e.g., 116). The stored association record may be accessed by at least one of: information identifying the language-agnostic artefact, information identifying the main label, or information identifying the at least one additional label within the multilingual artefact.

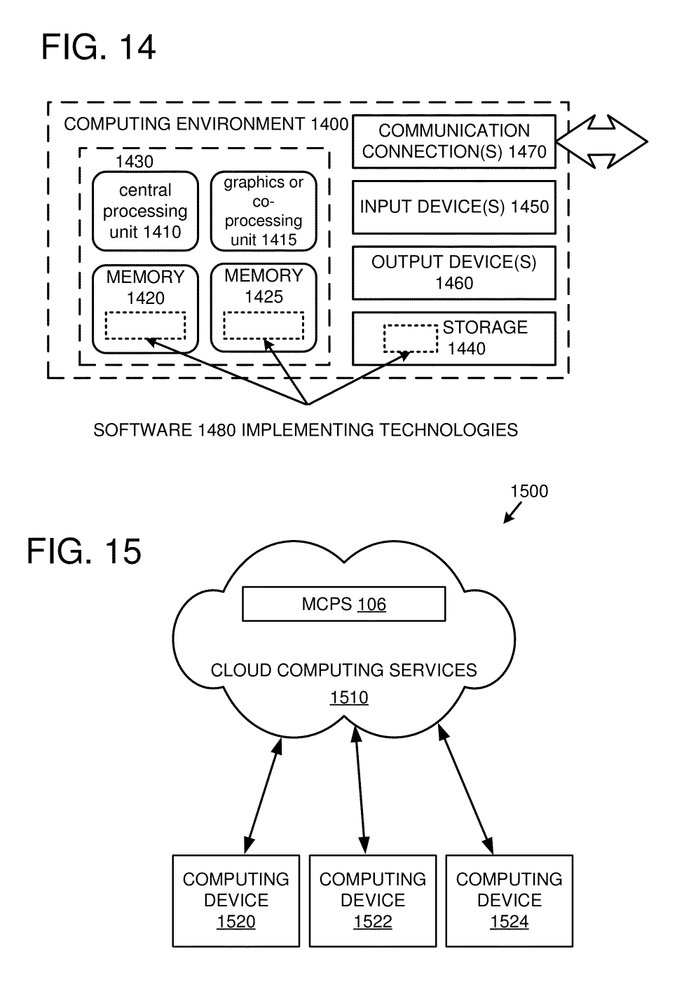

FIG. 14 is a diagram of an example computing system, in which described embodiments can be implemented. The computing system 1400 is not intended to suggest any limitation as to scope of use or functionality, as the innovations may be implemented in diverse general-purpose or special-purpose computing systems. With reference to FIG. 14, the computing system 1400 includes one or more processing units 1410, 1415 and memory 1420, 1425 (e.g., coupled to the processing units). In FIG. 14, this basic configuration 1430 is included within a dashed line. The processing units 1410, 1415 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 14 shows a central processing unit 1410 as well as a graphics processing unit or co-processing unit 1415. The tangible memory 1420, 1425 may be volatile memory (e.g., registers, cache, RAM), non-volatile memory (e.g., ROM, EEPROM, flash memory, etc.), or some combination of the two, accessible by the processing unit(s). The memory 1420, 1425 stores software 1480 implementing one or more innovations described herein, in the form of computer-executable instructions suitable for execution by the processing unit(s).

A computing system may have additional features. For example, the computing system 1400 includes storage 1440, one or more input devices 1450, one or more output devices 1460, and one or more communication connections 1470. An interconnection mechanism (not shown) such as a bus, controller, or network interconnects the components of the computing system 1400. Typically, operating system software (not shown) provides an operating environment for other software executing in the computing system 1400, and coordinates activities of the components of the computing system 1400.

The tangible storage 1440 may be removable or non-removable, and includes magnetic disks, magnetic tapes or cassettes, CD-ROMs, DVDs, or any other medium which can be used to store information in a non-transitory way and which can be accessed within the computing system 1400. The storage 1440 stores instructions for the software 1480 implementing one or more innovations described herein.

The input device(s) 1450 may be a touch input device such as a keyboard, mouse, pen, or trackball, a voice input device, a scanning device, or another device that provides input to the computing system 1400. For video encoding, the input device(s) 1450 may be a camera, video card, TV tuner card, or similar device that accepts video input in analog or digital form, or a CD-ROM or CD-RW that reads video samples into the computing system 1400. The output device(s) 1460 may be a display, printer, speaker, CD-writer, or another device that provides output from the computing system 1400.

The communication connection(s) 1470 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

FIG. 15 is an example cloud computing environment 1500 that can be used in conjunction with the technologies described herein. The cloud computing environment 1500 comprises cloud computing services 1510. The cloud computing services 1510 can comprise various types of cloud computing resources, such as computer servers, data storage repositories, networking resources, etc. The cloud computing services 1510 can be centrally located (e.g., provided by a data center of a business or organization) or distributed (e.g., provided by various computing resources located at different locations, such as different data centers and/or located in different cities or countries). Additionally, the cloud computing service 1510 may implement the MCPS 106 and other functionalities described herein relating to testing application code changes using a state assertion framework.

The cloud computing services 1510 are utilized by various types of computing devices (e.g., client computing devices), such as computing devices 1520, 1522, and 1524. For example, the computing devices (e.g., 1520, 1522, and 1524) can be computers (e.g., desktop or laptop computers), mobile devices (e.g., tablet computers or smart phones), or other types of computing devices. For example, the computing devices (e.g., 1520, 1522, and 1524) can utilize the cloud computing services 1510 to perform computing operators (e.g., data processing, data storage, and the like).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., non-transitory computer-readable media, such as one or more optical media discs such as DVD or CD, volatile memory components (such as DRAM or SRAM), or nonvolatile memory components (such as flash memory or hard drives)). By way of example and with reference to FIG. 14, computer-readable storage media include memory 1420 and 1425, and storage 1440. The term computer-readable storage media does not include communication connections (e.g., 1470) such as modulated data signals or carrier waves.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Pert, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations. As utilized herein, the term “processor” may be used to refer to one or more of a central processing unit, a processor of a symmetric or asymmetric multiprocessor system, a digital signal processor, a micro-controller, a graphics/video processor, or another type of processor.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a computing system, for provisioning multilingual content, the method comprising:
by the computing system:
receiving a selection of a language-agnostic artefact, the language-agnostic artefact comprising programming code for displaying a user interface with a text field;
receiving an input string designating at least a portion of a text label associated with the text field;
retrieving based on the received input string, a multilingual artefact from a plurality of available multilingual artefacts, the retrieved multilingual artefact comprising a plurality of translations of the input string into a plurality of human languages; and
creating an association record identifying an association between the language-agnostic artefact and the multilingual artefact.

2. The method according to claim 1, comprising:
displaying a list of the plurality of available artefacts, the list being automatically updated as each character of the input string is received.

3. The method according to claim 1, comprising:
receiving a selection of the multilingual artefact from the displayed list of the plurality of available artefacts.

4. The method according to claim 1, comprising:
receiving metadata associated with the text label, wherein the metadata comprises a domain information indicating subject area of usage and a text type information.

5. The method according to claim 4, comprising:
receiving a selection of the multilingual artefact from a database with the plurality of available artefacts, the database associated with a domain that matches the domain information in the received metadata.

6. The method according to claim 4, wherein the text type information comprises at least one of accessibility type information, description information, menu header information, column header information, or message text information.

7. The method according to claim 1, comprising:
storing the association record in network storage, wherein the stored association record is accessible by at least one of:
information identifying the language-agnostic artefact or information identifying at least one of the plurality of translations in the multilingual artefact.

8. The method according to claim 1, comprising:
in response to receiving the selection of the language-agnostic artefact, retrieving from a plurality of association records, at least one association record associating the selected language-agnostic artefact with at least one multilingual artefact.

9. The method according to claim 8, comprising:
displaying a list of the at least one multilingual artefact for selection.

10. The method according to claim 9, comprising:
receiving a selection of a multilingual artefact from the displayed list; and
completing the text field with a resource identifier associated with the selected multilingual artefact.

11. A computer-readable storage having instructions thereon that when executed cause a computing system to perform a method of provisioning multilingual content, the method comprising:
generating a language-agnostic artefact, the language-agnostic artefact comprising programming code for displaying a user interface with a text field;
receiving a query comprising:
an input string for completing the text field; and
metadata information designating a desired text type associated with the text field;
retrieving based on at least a portion of the received input string and the metadata information, a list of multilingual artefacts, each multilingual artefact comprising a plurality of translations of the at least a portion of the input string into a plurality of human languages;
receiving a selection of a multilingual artefact from the list of a plurality of multilingual artefacts; and
creating an association record identifying an association between the language-agnostic artefact and the selected multilingual artefact.

12. The computer-readable storage according to claim 11, wherein the method further comprises:
displaying a user interface for receiving the query.

13. The computer-readable storage according to claim 11, wherein the method further comprises:
matching the input string and the metadata information with multilingual content and metadata information associated with a plurality of available multilingual artefacts to generate the list.

14. The computer-readable storage according to claim 11, wherein the query further comprises domain information indicating subject area of usage of a corresponding multilingual artefact.

15. The computer-readable storage according to claim 11, wherein the method further comprises:
upon receiving the selection, generating a resource identifier associated with the selected multilingual artefact.

16. The computer-readable storage according to claim 15, wherein the method further comprises:
posting the resource identifier in the language-agnostic artefact so that at least a portion of the programming code defining the text field includes the resource identifier.

17. The computer-readable storage according to claim 11, wherein the method further comprises:
storing the association record in network storage, wherein the stored association record is accessible by at least one of information identifying the language-agnostic artefact or information identifying at least one of the plurality of translations in the multilingual artefact.

18. The computer-readable storage according to claim 11, wherein the method further comprises:
in response to generating the language-agnostic artefact, retrieving from a plurality of association records, at least one association record associating the language-agnostic artefact with at least one multilingual artefact.

19. The computer-readable storage according to claim 11, wherein the selected multilingual artefact comprises:
the at least a portion of the input string presented in a first human language;
domain information indicating subject area of usage of the multilingual artefact;
a text type associated with the at least a portion of the input string; and
at least one translation of the at least a portion of the input string into at least a second human language.

20. A computing device that includes a processor and a memory, the computing device being adapted to perform a method for provisioning multilingual content, the method comprising:
receiving a selection of a language-agnostic artefact, the language-agnostic artefact comprising programming code for displaying a user interface with a text field;
receiving input designating at least a portion of a text label associated with the text field;
retrieving a plurality of suggested text labels for the text field, the retrieving based on the received input, and each suggested text label comprising:
a main label for the text field, the main label in a first human language;
at least one additional label representing a translation of the main label in at least a second human language; and
an identifier designating a label type associated with the main label;
in response to receiving a selection of one of the plurality of suggested text labels, generating a multilingual artefact, wherein the multilingual artefact comprises a plurality of multilingual resource files identifying the main label and the at least one additional label;
creating an association record identifying an association between the language-agnostic artefact and the multilingual artefact; and
storing the association record in network storage, wherein the stored association record is accessible by at least one of: information identifying the language-agnostic artefact, information identifying the main label, or information identifying the at least one additional label within the multilingual artefact.
